(19) United States
(12) Patent Application Publication
(10) Pub. No.: US 2005/0005237 A1
(43) Pub. Date: Jan. 6, 2005

(54) Method for maintaining a centralized, multidimensional master index of documents from independent repositories

(76) Inventors: Peter D. Rail, Plano, TX (US); Denise R. Iverson, Allen, TX (US)

Correspondence Address: Stephen R. Loe;THE LAW OFFICE OF STEPHEN R. LOE, P.O. Box 649, Frisco, TX, 75034, US

(21) Appl. No.: 10/613,140

(22) Filed: Jul. 3, 2003

(51) Int. Cl. G06F 15/00

(52) U.S. Cl. 715/530

(57) ABSTRACT

A method, system, and computer program product for a document publication monitoring and management system which provides a centralized multidimensional master index of documents from a plurality of independent repositories is provided. In one embodiment, the system includes a monitoring unit on each of a plurality of contributor data processing systems, a document index hub, and a plurality of remote document repositories. The document index hub includes a stager, a deployer, a relayer; and at least one channel which is mapped to one or more physical storage devices. The stager translates channel information provided in the meta data of a published document to remote computer names and queues a file containing document transfer instructions to the deployer. The deployer performs file transfer instructions received from the stager and responsive to transfer fail, retries the transfer at specified time intervals. The relayer forwards meta data about the published document to an index hub to be cataloged.

### BACKGROUND OF THE INVENTION

1. Technical Field

The present invention relates generally to the field of computer software and, more specifically, to management of document collections for network publication.

2. Description of Related Art

The “Internet” is a worldwide network of computers. Today, the Internet is made up of more than 65 million computers in more than 100 countries covering commercial, academic and government endeavors. Originally developed for the U.S. military, the Internet became widely used for academic and commercial research. Users had access to unpublished data and journals on a huge variety of subjects. Today, the Internet has become commercialized into a worldwide information highway, providing information on every subject known to humankind.

The Internet's surge in growth in the latter half of the 1990s was twofold. As the major online services (AOL, CompuServe, etc.) connected to the Internet for e-mail exchange, the Internet began to function as a central gateway. A member of one service could finally send mail to a member of another. The Internet glued the world together for electronic mail, and today, the Internet mail protocol is the world standard.

Secondly, with the advent of graphics-based Web browsers such as Mosaic and Netscape Navigator, and soon after, Microsoft's Internet Explorer, the World Wide Web took off. The Web became easily available to users with PCs and Macs rather than only scientists and hackers at UNIX workstations. Delphi was the first proprietary online service to offer Web access, and all the rest followed. At the same time, new Internet service providers rose out of the woodwork to offer access to individuals and companies. As a result, the Web has grown exponentially providing an information exchange of unprecedented proportion. The Web has also become “the” storehouse for drivers, updates and demos that are downloaded via the browser.

Many enterprises use the Web to make documents available publicly. Often, the number of documents made available by an enterprise may be in the thousands or millions and come from a variety of sources within the enterprise. Thus, it is unrealistic to assume there is a single, well-categorized and highly controlled document collection for an entire enterprise. Instead, various ad hoc and departmental repositories coexist as islands of valuable information within a single enterprise. Some departments will be strict about which documents are worthy of inclusion in their repository, while others will have more informal governance rules. In addition, there may be no standard classification scheme among these independent repositories and the document quality could vary. Although this distributed repository model has clear advantages in its autonomy and flexibility, it is difficult for the entire enterprise to benefit from the documents because they are hard to locate.

Ideally these documents would follow a standard classification scheme and be easily accessibly by all. But to offer this would require departments to agree to use a centralized document management tool—a disruptive and expensive undertaking that risks failure because of the inevitable resistance to change.

Therefore, it is desirable to have a document management system that neatly sidesteps these problems by offering methods to categorize and index documents in one place while preserving the autonomy of the independent repositories.

### SUMMARY OF THE INVENTION

The present invention provides a method, system, and computer program product for a document publication monitoring and management system which provides a centralized multidimensional master index of documents from a plurality of independent repositories. In one embodiment, the system includes a monitoring unit on each of a plurality of contributor data processing systems, a document index hub, and a plurality of remote document repositories. The document index hub includes a stager, a deployer, a relayer; and at least one channel which is mapped to one or more physical storage devices. The stager translates channel information provided in the meta data of a published document to remote computer names and queues a file containing document transfer instructions to the deployer. The deployer performs file transfer instructions received from the stager and responsive to transfer fail, retries the transfer at specified time intervals. The relayer forwards meta data about the published document to an index hub to be cataloged.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a schematic diagram illustrating a high level representation of the document publication engine in accordance with one embodiment of the present invention;

FIG. 5 depicts a schematic diagram illustrating the document publication hardware configuration in accordance with an embodiment of the present invention;

FIG. 6 depicts a schematic diagram illustrating the structure of the document publication engine repository software components on a contributor machine in accordance with the present invention; and

FIG. 7 depicts a schematic diagram illustrating a document index hub in accordance with one embodiment of the present invention.

### DETAILED DESCRIPTION OF THE PREFERRED EMBODIMENT

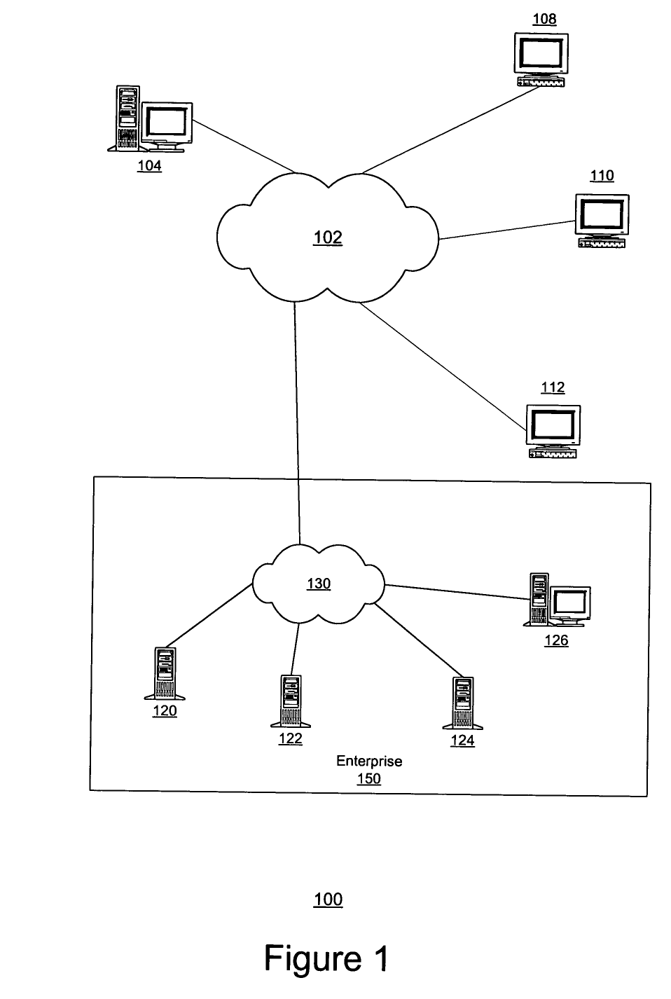

With reference now to the figures, and in particular with reference to FIG. 1, a pictorial representation of a distributed data processing system is depicted in which the present invention may be implemented. Distributed data processing system 100 represents one embodiment of the hardware components of an IT service for a company or other entity.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Distributed data processing system 100 may include additional servers, clients, and other devices not shown.

In the depicted example, distributed data processing system 100 is an intranet, with network 102 representing a company wide collection of networks and gateways that use, for example, the TCP/IP suite of protocols or a proprietary suite of protocols to communicate with one another. Of course, distributed data processing system 100 also may be implemented as a number of different types of networks such as, for example, the Internet, a Virtual Private Network (VPN), or a local area network.

Also connected to network 102 is an Enterprise 150 having its own internal network 130 through which data processing systems 120-126 are connected to the intranet network 102. Various components of a document publication engine runs on data processing systems 120-126 enabling documents created by various departments within the enterprise to be published such that the documents are accessible via the intranet network 102. The document publication engine allows each department within the Enterprise 150 to maintain its own repositories for documents and its own naming and other conventions for these documents. A central component of the document publication engines runs on data processing system 126. This central component provides a centralized multidimensional master index of documents from the independent document repositories maintained by each department within the Enterprise 150.

Enterprise 150 may include other devices and hardware and devices not depicted in FIG. 1. The document publication engine will be described in greater detail below.

FIG. 1 is intended as an example and not as an architectural limitation for the processes of the present invention.

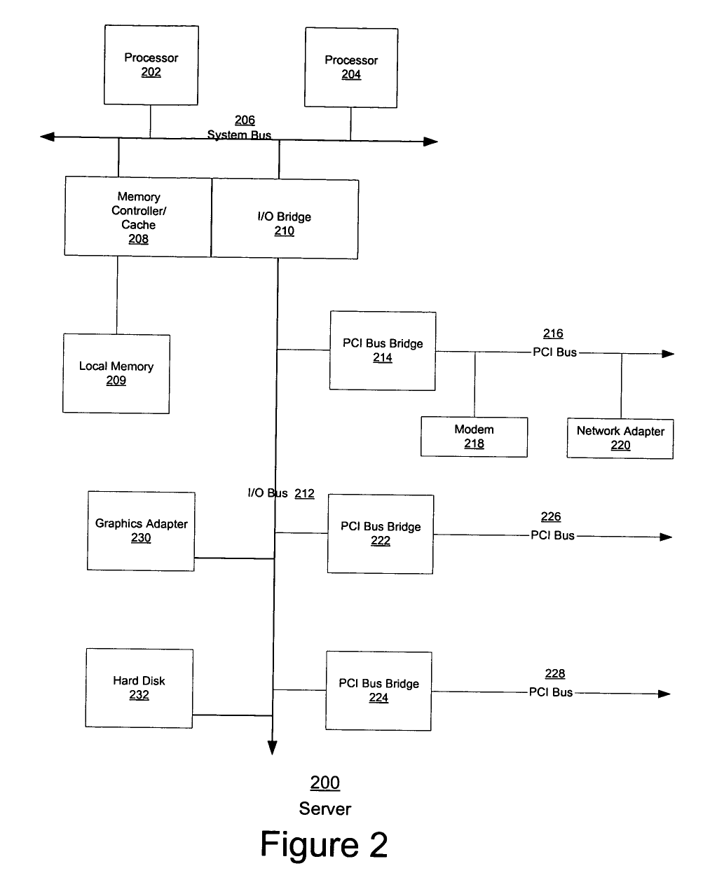

Referring to FIG. 2, a block diagram of a data processing system which may be implemented as a server, such as servers 104, and 120-126 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

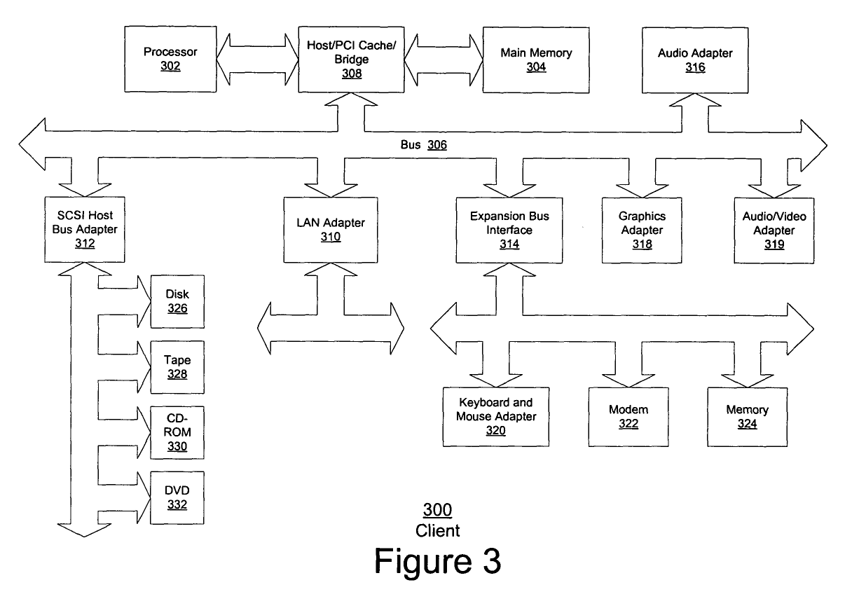

With reference now to FIG. 3, a block diagram of a data processing system in which the present invention may be implemented is illustrated. Data processing system 300 is an example of a client computer, such as any of client computers 108-112 depicted in FIG. 1. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

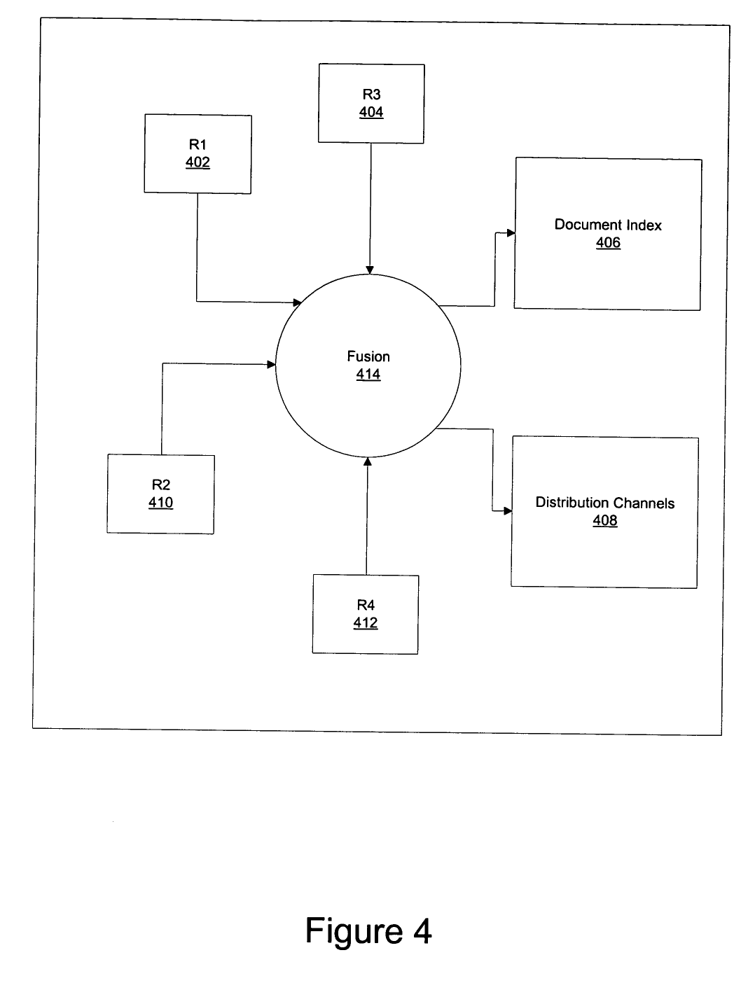

Turning now to FIG. 4, a schematic diagram illustrating a high level representation of the document publication engine is depicted in accordance with one embodiment of the present invention. Henceforth, the document publication engine will be referred to simply as “DPE”.

R1 402, R2 410, R3 404, and R4 412 represent independent document repositories. Each document repository 402, 410, 404, and 412 forwards documents and meta data to DPE 414, which distributes the documents through distribution channels 408 for viewing on the web while maintaining a consolidated document index 406.

From this simple diagram one might assume that DPE 414 is a kind of web crawler that follows links to pages and builds indexes like Google does. However, this would be incorrect. Although DPE 414 contains a search facility, it does not maintain its document index 406 through crawling, but rather through a subscription model. DPE 414 works by monitoring workflow events in document repositories 402, 410, 404, and 412 and updating a centralized master document index 406 to reflect changes in document text and meta data. In the current implementation, DPE employs the Inktomi search engine to provide full text and meta data searches for documents it has cataloged. However, any search engine that is capable of searching meta information as well as capable of performing a full text search is acceptable.

DPE 414 may be implemented within enterprise 150 in FIG. 1 with various components implemented on each departmental machine 120-124 and a central component containing the document index and other main DPE components implemented on server 126.

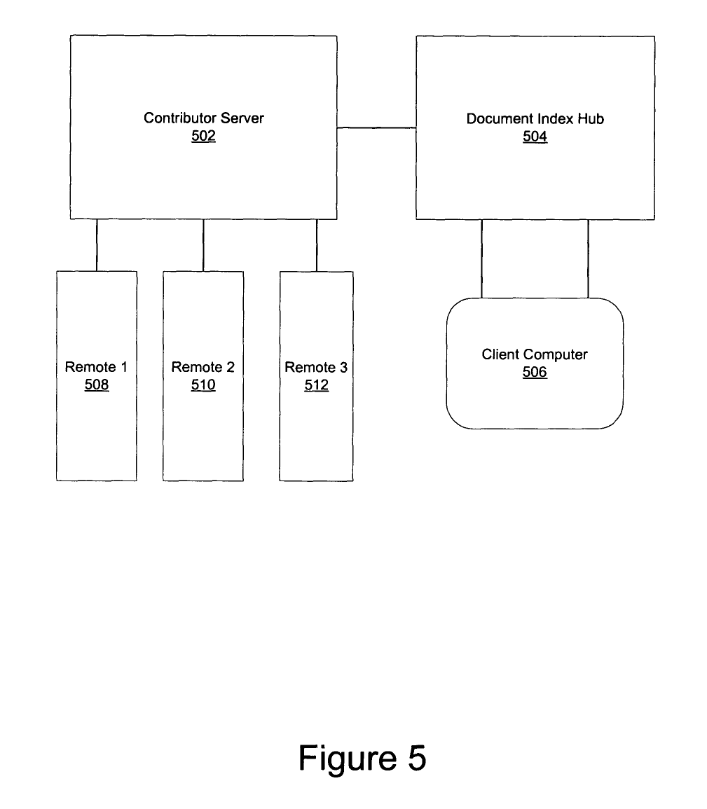

Turning now to FIG. 5, a schematic diagram illustrating the DPE hardware configuration is illustrated in accordance with an embodiment of the present invention.

The contributor machine 502 holds the document repository and the repository workflow monitor software for a specific department. Each department may have numerous machines each with its own document repository and repository workflow monitor or a department may have a shared document repository on one or more machines, but with each data processing system within the department containing the repository workflow monitor software. When a publish event is detected by the repository workflow monitor software, the document is copied from the department repository to one or more remote machines 508-512. Next, the document's meta data is relayed to the Document Index Hub 504 where it is indexed and categorized along with the full text of the document. The meta data may include information such as, for example, author name, department, and subject matter of the document. Finally, a client computer 506, either an end user or a software program, may query the document index hub 504 to locate documents on the remote machines 508-512 which match criteria specified by the client computer 506.

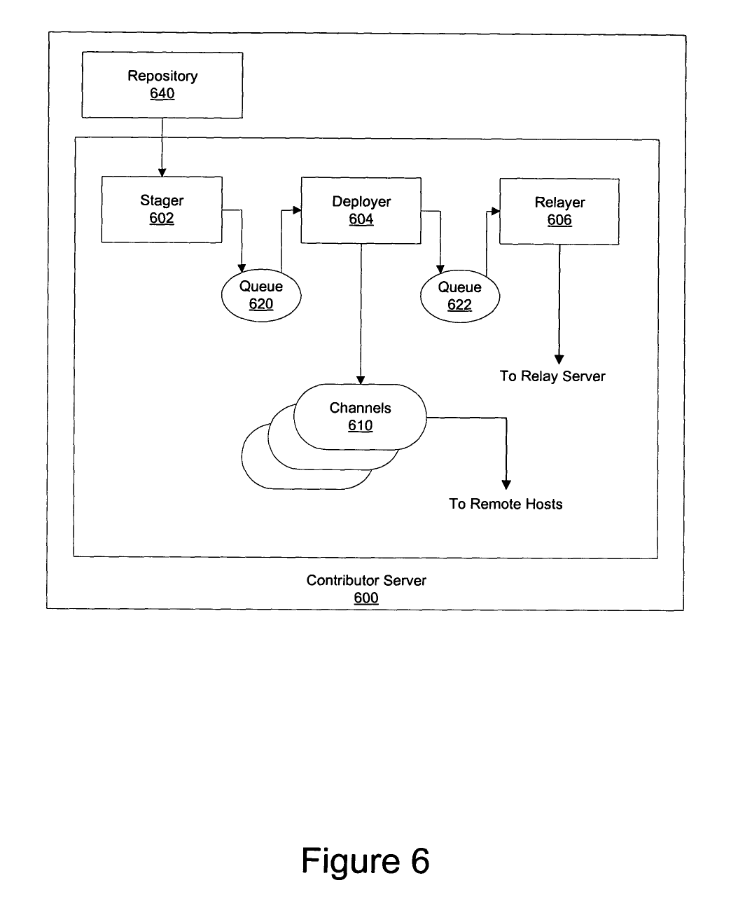

Turning now to FIG. 6, a schematic diagram illustrating the structure of the DPE repository software components on a contributor machine is depicted in accordance with the present invention.

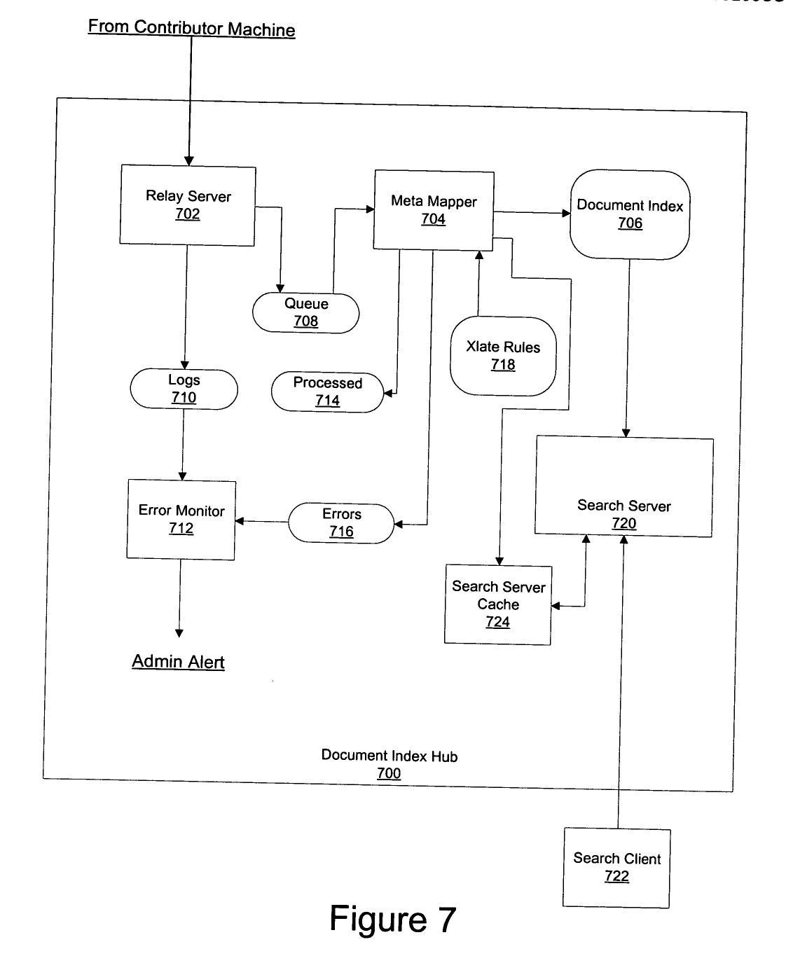

The contributor machine 600 contains and repository software components 602, 604, 606, 620, 622, and 610 and is connected to a departmental document repository 640 which may be located either within the contributor machine or external to the contributor machine. The repository software components 602, 604, 606, 620, 622, and 610 are used to copy documents to channels and to relay meta data to the Document Index Hub. The repository software 602, 604, 606, 620, 622, and 610 is expected to inform DPE's main centralized components, described below with reference to FIG. 7, when a document is published, updated, or deleted.

Besides the usual document management duties, the Repository 640 is responsible for keeping DPE informed of document adds and deletes. When a document is published, the Repository provides the Stager 602 component with meta data describing the document and containing channel information. When a document is deleted, the Stager 602 is also informed. For simplicity, in this embodiment, only add or delete instructions are supported. (Other embodiments may include other features). However, by supporting only add and delete instructions, if the Repository 640 wants to signal an update event, it will send a delete followed by an add.

The Stager 602 translates channel information provided in the meta data to remote computer names and queues an Extensible Markup Language (XML) file containing document transfer instructions for the Deployer 604. In other embodiments, other types of file structures may be used rather than XML files. The Stager 602 also writes the meta data describing the document to the queue 620. Furthermore, document types other than text documents, such as, for example, graphic files, such as .JPEG or .BMP files, video files such as .MPEG files, and audio files, such as, .WAV files, may have meta data attached to allow searching for these documents as well.

The Deployer 604 performs file transfer instructions it receives in queue 620 using, for example, File Transfer Protocol (FTP), to transfer the file to one or more channels 610. If the transfer fails, the Deployer 604 will retry periodically until it succeeds. The retry intervals may be set to a simple set time period or a more complex retry interval may programmed such as, for example, having each successive interval be double the timer period of the previous time interval or by using a Fibonacci sequence to calculate successive time intervals. By using more complex retry intervals, system degradation may be avoided by not having the Deployer 604 continually attempting to transfer to channels 610 when it is obvious that the file transfer to the channels 610 cannot take place under the current conditions of the contributor machine 600 or of the channels 610. Once the transfer succeeds to all the hosts identified by the channel, the Deployer 606 places the meta data file in the relay queue 622.

The Relayer 606 is responsible for forwarding meta data about documents to the Index Hub 504 where the document is cataloged. If the Index Hub 504 is unavailable, the Relayer 606 will attempt to resend the meta data until successful. The Relayer 604 also forwards status records from DPE components to the Index Hub 504 where they are logged and monitored for errors.

A series of queues 620 and 622 is useful to guarantee delivery of documents to remote hosts and meta data to the Index Hub 504. Without the queues 620 and 622, critical document updates could be lost if a remote host or the Index Hub machine 504 is unavailable because of a network problem.

A channel 610 is a useful abstraction representing one or more remote host computers. It is intended to free the repository contributors from thinking about the physical deployment of documents and concentrate instead on writing and categorization. The channels also allow technical staff the flexibility to change the names or configurations of remote hosts without affecting repository settings. This is a chief consideration considering that in a large enterprise, this might not be the same technical staff responsible for the repository.

The value of the channel concept becomes clear when you consider clustered environments where multiple computers are fronted by a switch or “load balancer” to provide high availability and fail over. Without channels, the repository software, or worse yet, the repository user would be expected to know the physical machine names (and directories) to send a finished copy of the document. Clearly this is not reasonable and is likely to be error prone.

In addition to the components depicted in FIG. 6, the repository software may include user interface components that allow a user to provide the DPE with various meta data and other data. For example, the user interface may prompt the user to determine whether the document that is being published belongs to a group of related documents, such as, for example, translated documents. If the repository software determines that the document belongs to a group of related documents that should be provided to a search engine as a single search result entry, the repository software may query the user to determine the identity of the other documents within the group and attach appropriate meta information to the document to identify the document as belonging to the specified group as well as identifying all other documents that belong to the same group as the document.

Turning now to FIG. 7, a schematic diagram illustrating a document index hub is depicted in accordance with one embodiment of the present invention. Document index hub 700 may be implemented as document index hub 504 in FIG. 5.

The document index hub 700 includes a relay server 702, a meta mapper 704, a document index 706, a search server 720, a search client 722, a search server cache 724, and an error monitor 712. In the document index hub 700 meta data describing documents is received and cataloged in a document index 706. Status records from the Stager 602, Deployer 604, and Relayer 606 components running on remote Contributor Machines 600 are captured and monitored in the document index hub 700.

The relay server 702 receives meta data and status information from the Contributor Machines 600. The relay server 702 writes the status information to a daily log file 710 and queues the meta data for the Meta Mapper 704.

The Meta Mapper 704 standardizes and, in some cases, augments the meta data originating with Contributor Machines 600 and updates the Document Index 706. The Meta Mapper 704 uses translation rules 718 to accomplish this standardization. This step is fundamental to DPE since it enables truly independent repositories to coexist within the same enterprise with categories that differ.

A simple case of mapping one set of meta data to another will illustrate the point: suppose one repository chooses to store an attribute called “date created”, but the master index calls it “creation date.” The Meta Mapper is responsible for translating one name to the other and resolving any format differences.

More complex mappings such as industries and regions are possible too. For example, suppose the Meta Mapper receives an attribute called “region” with a value of “Michigan.” The process will recognize “region” as a hierarchical attribute and add the additional attributes of “United States” and “Midwest US” to the meta data before updating the Document Index.

As another example, different entities within the enterprise may variously use the terms summary, abstract and snippet to refer to the same part of a document. The Meta Mapper is programmed to recognize that within this enterprise, these words are interchangeable, and maps each of these meta tags to the meta tag “Summary”.

Additionally, the Meta Mapper may add meta tags based on implications from the meta tags supplied with a document from a document repository. For example, a meta tag that indicates that document originated or is for “Michigan” also implies that the document is a “United States” document and a “North American” document. The Meta Mapper adds these additional meta tags so that people or software searching for “United States” or “North American” documents will find this “Michigan” document as well.

In addition to mapping departmental formatted meta tags to an enterprise wide standard meta tag format, the meta mapper may add meta tags to documents indicating that the documents are part of a group of documents. For example, the CEO of a corporation may record a welcome address to new employees that is made available through a company wide intranet. The welcome address may be available in a variety of video formats. The welcome address may also have been translated to several languages. Also, the welcome address may be provided as an audio only format as well as text transcriptions of the address in a variety of formats such as MS Word and PDF files. The Meta mapper may add a tag to each document indicating that it belongs to a group and indicating the identity of the other documents within the group such that when a search is performed, rather than displaying an entry for each of these documents whose content is identical, but format is different, a single entry is displayed within the search return. The single entry indicates the various formats in which the welcome address is available. This improves the efficiency of searching for end users since they do not have to wade through tens or hundreds of documents which have essentially the same content in different formats.

The Search Server 720 accepts meta data or keyword queries and returns a matching list of document attributes, including links to the document on the remote hosts. It can provide the list of matching documents in several formats including, for example, Hypertext Markup Language (HTML), XML, and plain text. The Search Client 722 is expected to specify the desired format as part of the search request.

The Search Server 720 updates the Search Server cache 724 as it retrieves query results. When a new query is received from the Search Client 722, the Search Server 720 first checks the Search Server Cache 724 to determine if the same search has already been performed. If it has, the Search Server 720 merely retrieves the search result from the Search Server Cache 724 and sends this to the Search Client 722 thus eliminating needless accessing of the Document Index 706 and saving time. The Meta Mapper 704 deletes stale information within the Search Server Cache 724 when it detects a document update or a publish event for a document that is contained within cached search result. A cross reference is kept in the cache between the Document IDs and the query result-sets. When a document is deleted/changed, then the cache is probed by the Meta Mapper 704 to determine which result sets are now stale. The stale result sets are deleted to force the Search Server 720 to read the most up-to-date results from permanent storage.

The Search Client 722 may be an end user, portlet, or web page that issues a query to the Search Server 720. By allowing a web page to embed a query, dynamic document lists are possible. This feature saves web masters many hours of work manually updating document lists. For example, a web master may wish to have links on a web page that link to each price list document for all service offerings issued by the enterprise in North America in the past three years. Rather than manually finding and entering links to these documents within the web page, the web master merely embeds code within the web page that performs a search of the document index hub for the specified document types and creates links within the web page to each document found from the document index hub. Thus, the web master for a particular web page need not be familiar with the document formatting used by each department or entity within the enterprise to find relevant documents for the web page, but must merely code to have a search of the document index hub.

This allows information from one part of the entity to be shared with another part of the entity relatively seamlessly and effortlessly. Such a feature may not be terribly important for small organizations, but may be vital for large organizations where there are thousands of people in different departments constantly creating documents that may also have relevance to others within the organization. Thus, the present invention allows large organizations to leverage the skills and experiences of a large number of people. Therefore, the same work need not be performed twice by different people in different parts of the organization working independently of each other and having no knowledge of the other's work, since people in different departments within the same enterprise now have much more greater access to the assets of the enterprise.

Furthermore, because many searches can be performed by web pages created specifically for various types of people within the organization by web masters having knowledge of the formatting of the document index hub, but not necessarily knowledge of the document management practices of any specific department, and because the web masters know the types of things important to the audience for which their web page is created, more of the enterprise's document assets are available to each individual in the enterprise. However, more importantly, the document lists may be shorter and more relevant to the end user because the documents are tagged more efficiently by the present invention allowing a web master to create a better more focused search.

The Error Monitor 712 periodically reads the status log 710 and alerts the support staff via e-mail when a problem has been detected. An example of a problem is a file transfer that cannot be completed. This may indicate, for example, that a remote host has a configuration error or that there is a network routing problem. It may also indicate that one or more of the channels is full preventing future documents from being published. To prevent a document from failing to copy to one or more channels, each channel may be implemented with a reserve file occupying, for example, 100 megabytes of disk storage space. If the channel is full, DPE simply deletes the reserve file, copies the document and alerts support staff that additional space will be required on the particular channel.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for maintaining a centralized index of documents stored in a plurality of independent document repositories, the method comprising:
monitoring a networked computing environment for publish events; and
responsive to detecting a publish event, relaying a published document's meta data to a document index hub which indexes and categorizes the document's meta data and copying the published document to at least one remote storage device.

2. The method as recited in claim 1, wherein the meta data comprises channel information detailing which of a plurality of channels the document is to be copied to where the channel represents at least one of the remote storage devices.

3. The method as recited in claim 1, further comprising:
mapping a document's meta data to a uniform meta data format.

4. The method as recited in claim 1, further comprising:
responsive to a determination that the document does not have meta data, creating meta data and adding the meta data to the document.

5. The method as recited in claim 4, wherein the document is one of a video document, a graphic document, and an audio document.

6. The method as recited in claim 4, further comprising:
prompting a user to input appropriate meta data.

7. The method as recited in claim 1, further comprising:
responsive to a determination that the document belongs to a group of documents, adding a meta tag indicating that the document belongs to a group of documents and an indication of the identity of the other documents within the group of documents.

8. A computer program product in a computer readable media for use in a data processing system for maintaining a centralized index of documents stored in a plurality of independent document repositories, the computer program product comprising:
first instructions for monitoring a networked computing environment for publish events; and
second instructions, responsive to detecting a publish event, for relaying a published document's meta data to a document index hub which indexes and categorizes the document's meta data and copying the published document to at least one remote storage device.

9. The computer program product as recited in claim 8, wherein the meta data comprises channel information detailing which of a plurality of channels the document is to be copied to where the channel represents at least one of the remote storage devices.

10. The computer program product as recited in claim 8, further comprising:
third instructions for mapping a document's meta data to a uniform meta data format.

11. The computer program product as recited in claim 8, further comprising:
third instructions, responsive to a determination that the document does not have meta data, for creating meta data and adding the meta data to the document.

12. The computer program product as recited in claim 11, wherein the document is one of a video document, a graphic document, and an audio document.

13. The computer program product as recited in claim 11, further comprising:
fourth instructions for prompting a user to input appropriate meta data.

14. The computer program product as recited in claim 8, further comprising:
third instructions, responsive to a determination that the document belongs to a group of documents, for adding a meta tag indicating that the document belongs to a group of documents and an indication of the identity of the other documents within the group of documents.

15. A system for maintaining a centralized index of documents stored in a plurality of independent document repositories, the system comprising:
first means for monitoring a networked computing environment for publish events; and
second means, responsive to detecting a publish event, for relaying a published document's meta data to a document index hub which indexes and categorizes the document's meta data and copying the published document to at least one remote storage device.

16. The system as recited in claim 15, wherein the meta data comprises channel information detailing which of a plurality of channels the document is to be copied to where the channel represents at least one of the remote storage devices.

17. The system as recited in claim 15, further comprising:
third means for mapping a document's meta data to a uniform meta data format.

18. The system as recited in claim 15, further comprising:
third means, responsive to a determination that the document does not have meta data, for creating meta data and adding the meta data to the document.

19. The system as recited in claim 18, wherein the document is one of a video document, a graphic document, and an audio document.

20. The system as recited in claim 18, further comprising:
fourth means for prompting a user to input appropriate meta data.

21. The system as recited in claim 15, further comprising:
third means, responsive to a determination that the document belongs to a group of documents, for adding a meta tag indicating that the document belongs to a group of documents and an indication of the identity of the other documents within the group of documents.

22. A method for maintaining a centralized index of documents stored in a plurality of independent document repositories, the method comprising:
receiving a document from a contributing data processing system;
mapping meta data contained within the document to standardized meta data in a standardized meta data format; and
storing a copy of the document and the standardized meta data in a document index hub.

23. The method as recited in claim 22, further comprising:
responsive to a determination that meta data within the document implies other standardized meta data, adding the other standardized meta data to the document.

24. The method as recited in claim 22, further comprising:
receiving a search request from a client data processing system;
identifying matching documents having content and standardized meta data matching search criteria specified in the search request; and
sending a search result identifying the matching documents to the client data processing system.

25. The method as recited in claim 24, further comprising:
responsive to a determination that a document matching the search criteria belongs to a group of documents with similar content, formatting the search result such that all documents belonging to the group are identified within a single entry within the search results.

26. The method as recited in claim 24, wherein the search result includes hyperlinks to at least one of the matching documents.

27. The method as recited in claim 24, wherein the search request from the client data processing system is embedded within a web page.

28. A computer program product in a computer readable media for use in a data processing system for maintaining a centralized index of documents stored in a plurality of independent document repositories, the computer program product comprising:
first instructions for receiving a document from a contributing data processing system;
second instructions for mapping meta data contained within the document to standardized meta data in a standardized meta data format; and
third instructions for storing a copy of the document and the standardized meta data in a document index hub.

29. The computer program product as recited in claim 28, further comprising:
fourth instructions, responsive to a determination that meta data within the document implies other standardized meta data, for adding the other standardized meta data to the document.

30. The computer program product as recited in claim 28, further comprising:
fourth instructions for receiving a search request from a client data processing system;
fifth instructions for identifying matching documents having content and standardized meta data matching search criteria specified in the search request; and
sixth instructions for sending a search result identifying the matching documents to the client data processing system.

31. The computer program product as recited in claim 30, further comprising:
seventh instructions, responsive to a determination that a document matching the search criteria belongs to a group of documents with similar content, for formatting the search result such that all documents belonging to the group are identified within a single entry within the search results.

32. The computer program product as recited in claim 30, wherein the search result includes hyperlinks to at least one of the matching documents.

33. The computer program product as recited in claim 30, wherein the search request from the client data processing system is embedded within a web page.

34. A system for maintaining a centralized index of documents stored in a plurality of independent document repositories, the system comprising:
first means for receiving a document from a contributing data processing system;
second means for mapping meta data contained within the document to standardized meta data in a standardized meta data format; and
third means for storing a copy of the document and the standardized meta data in a document index hub.

35. The system as recited in claim 34, further comprising:
fourth means, responsive to a determination that meta data within the document implies other standardized meta data, for adding the other standardized meta data to the document.

36. The system as recited in claim 34, further comprising:
fourth means for receiving a search request from a client data processing system;
fifth means for identifying matching documents having content and standardized meta data matching search criteria specified in the search request; and
sixth means for sending a search result identifying the matching documents to the client data processing system.

37. The system as recited in claim 36, further comprising:
seventh means, responsive to a determination that a document matching the search criteria belongs to a group of documents with similar content, for formatting the search result such that all documents belonging to the group are identified within a single entry within the search results.

38. The system as recited in claim 36, wherein the search result includes hyperlinks to at least one of the matching documents.

39. The system as recited in claim 36, wherein the search request from the client data processing system is embedded within a web page.

40. A document index hub, comprising:
a relay server which receives meta data and status information for a document from a document publishing data processor;
a meta mapper which translates the meta information for the document to a standardized meta information format; and
a document index which indexes and categorizes the document's meta data.

41. The document index hub as recited in claim 40, further comprising:
a search server which receives at least one of meta data and keyword entries from a remote search client, wherein the search server returns to a matching list of document attributes to the search client.

42. The document index hub as recited in claim 41, wherein the matching list of document attributes includes links to the documents on a remote host.

43. The document index hub as recited in claim 41, wherein the matching list of document attributes is presented on one of Hypertext Markup Language format, Extensible Markup Language format, and plain text format.

44. The document index hub as recited in claim 40, wherein the relay server writes status information to a log file.

45. The document index hub as recited in claim 44, further comprising:
an error monitor which reads the log file and alerts support staff when a problem is detected.

46. The document index hub as recited in claim 40, wherein the meta mapper recognizes that meta information within the document implies additional meta information and inserts that additional meta information within the document.

47. The document index hub as recited in claim 40, wherein the meta mapper recognizes that the document is a new member of a group of documents and updates meta information in the other members of the group of documents to indicate that the document belongs to the group.

48. A document publication monitoring system, comprising:
a stager;
a deployer;
a relayer; and
at least one channel; wherein
the stager translates channel information provided in the meta data of a published document to remote computer names and queues a file containing document transfer instructions to the deployer;
the deployer performs file transfer instructions received from the stager and responsive to transfer fail, retries to transfer at specified time intervals; and the relayer forwards meta data about the published document to an index hub to be cataloged; and
the relayer forwards meta data about the document to the an index hub.

49. The document publication monitoring system as recited in claim 48, wherein the specified time intervals are determined by one of doubling a time interval to determine a successive time interval and using a Fibonacci sequence to calculate successive time intervals.

50. The document publication monitoring system as recited in claim 48, further comprising a user interface wherein the user interface prompts a user to identify whether a document belongs to a group of documents and, responsive to a determination that the document belongs to a group of documents, collects information from the user to identify the other documents within the group.
